(19) United States
(12) Patent Application Publication
(10) Pub. No.: US 2014/0173442 A1
(43) Pub. Date: Jun. 19, 2014

(54) PRESENTER VIEW IN PRESENTATION APPLICATION

(71) Applicant: MICROSOFT CORPORATION, Redmond, WA (US)

(72) Inventors: Lishan Yu, San Jose, CA (US); Christopher Michael Maloney, San Francisco, CA (US); Diana Gail Kimball, Boston, MA (US); Trevor Bradshaw Florence, Mountain View, CA (US); Shawn Alan Villaron, San Jose, CA (US); Hannes Ruescher, Palo Alto, CA (US); Jeffrey Edwin Murray, Mountain View, CA (US)

(73) Assignee: MICROSOFT CORPORATION, Redmond, WA (US)

(21) Appl. No.: 13/717,705

(22) Filed: Dec. 18, 2012

(51) Int. Cl. G06F 3/0484

(52) U.S. Cl. CPC G06F 3/04845
USPC 715/732; 715/730

(57) ABSTRACT

Technologies are described herein for providing a presenter view in a presentation application. A determination is made, by a presentation application executing on a computer, as to whether a secondary display device is coupled to the computer. If a determination is made that the secondary display device is coupled to the computer, then the presentation application is transformed from a default configuration to a presenter configuration. If a determination has been made that the presentation is complete, then the presentation application is transformed from a presenter configuration to a default configuration.

### BACKGROUND

Generally, presentation applications offer both a development environment and a presentation environment. A presenter may utilize the development environment to create a slideshow set. A typical slideshow set may include a collection of slides, each of which contains text, images, sound, video, or combinations thereof. The presenter may utilize the presentation environment to present the slideshow set to an audience and to transition from one slide to another during the presentation.

In an example presentation system configuration, a computer may be coupled to a projection device. The computer may execute a presentation application configured to display a slideshow set via the projection device. The projection device may be arranged to project the slideshow set to a large screen in front of an audience. The presenter may utilize an input device coupled to the computer in order to transition from one slide to another slide during a presentation of the slideshow set.

In a common scenario, the computer includes a primary display device, and the projection device serves as a secondary display device. However, some presentation applications merely duplicate the display shown on the primary display device and by the projection device. Such utilization of the primary display device may be inefficient because the primary display device, which is often private to the presenter (i.e., not viewable by the audience), could be utilized to assist the presenter during the presentation.

It is with respect to these and other considerations that the disclosure made herein is presented.

### SUMMARY

Technologies are described herein providing a presenter view in a presentation application. The presentation application may be executed on a computer that is coupled to primary display device and optionally to a secondary display device. The presentation application may determine whether the secondary display device is coupled to the computer. If the presentation application determines that the secondary display device is coupled to the computer, then the presentation application may configure to a presenter configuration. In the presentation configuration, a presenter view may be shown on the primary display device, and a slideshow view may be shown on the secondary display device.

The presenter view may include a current slide area, a private preview area, notes area, and a control interface. The current slide area may show a reduced-size rendering of the current slide that is concurrently shown in the slideshow view. The private preview area may show a reduced-size rendering of a next slide following the current slide or a next animation of the current slide. The notes area may show presentation notes for a presenter. The control interface may include various interface elements configured to provide access to various controls. Some example controls include a private zoom control, a private navigation grid control, a private black screen control, a private show taskbar control, a private display settings control, a private timer interface, and a private laser pointer control.

In some example technologies, a method for providing a presenter view in a presentation application is provided. According to the method, a determination is made, by the presentation application executing a computer, as to whether a secondary display device is coupled to the computer. If a determination is made that the secondary display device is coupled to the computer, then the presentation application is transformed from a default configuration to a presenter configuration.

It should be appreciated that the above-described subject matter may also be implemented as a computer-controlled apparatus, a computer process, a computing system, or as an article of manufacture such as a computer-readable storage medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a block diagram illustrating a computing device configured to provide a presenter view in a presentation application, in accordance with some embodiments presented herein;

FIGS. 2A-2D are screen display diagrams illustrating an example process for zooming in on a slide, in accordance with some embodiments presented herein;

FIG. 3A is a screen display diagram showing an example implementation of a navigation grid, in accordance with some embodiments presented herein;

FIG. 3B is a screen display diagram showing an example implementation of a navigation grid in combination with a section pane, in accordance with some embodiments presented herein;

FIG. 3C is a screen display diagram showing an alternative example implementation of a section pane, in accordance with some embodiments presented herein;

FIG. 4 is a flow diagram illustrating an example method for providing a presenter view in a presentation application, in accordance with some embodiments presented herein; and

FIG. 5 is a computer architecture diagram showing an illustrative computer hardware architecture for a computing system capable of implementing the embodiments presented herein.

### DETAILED DESCRIPTION

The following detailed description is generally directed to concepts and technologies for providing a presenter view in a presentation application. A presenter may execute the presentation application on a computer. The presentation application may be configured to show a slideshow set (e.g., a collection of slides) on one or more display devices coupled to the computer. The computer may be coupled to a primary display device. The computer may also be optionally coupled to a secondary display device, such as a projection device. The primary display device may be arranged such that the primary display device is visible only to the presenter. The secondary display device may be arranged such that the secondary display device is visible to an audience as well as the presenter.

In an illustrative implementation, the presenter may initiate the presentation application on the computer. The presentation application may determine whether the secondary display device is coupled to the computer. In response to determining that the secondary display device is coupled to the computer, the presentation application may automatically initiate a presenter configuration of the presentation application. In the presenter configuration, the presentation application may cause the computer to render a presenter view on the primary display device and to render a slideshow view on the secondary display device.

In a first embodiment of the presenter configuration, the presenter view may be configured with a private zoom control. The private zoom control may be visible in the presenter view to the presenter but not in the slideshow view to the audience. When a current slide is shown in the slideshow view to the audience, a reduced-size rendering of the current slide may be shown in the presenter view to the presenter. The presenter may select the private zoom control in order to access a zoom interface in the presenter view. Through the presenter view, the presenter may select a portion of current slide to which to zoom in. After the presenter has committed to the zoom interface, a zoomed-in view of the selected portion of the current slide is shown in the slideshow view to the audience.

In a second embodiment of the presenter configuration, the presenter view may be configured with a private navigation grid control. The private navigation grid control may be visible in the presenter view to the presenter but not in the slideshow view to the audience. The presenter may select the private navigation grid control in order to access a navigation grid in the presenter view. The navigation grid may show corresponding thumbnail images of multiple slides from the slideshow set. If the slides in the slideshow set are organized by sections, then the navigation grid may show the thumbnail images of the slides as organized by section. The presenter may utilize the navigation grid in order to transition to another slide in the slideshow set.

In a third embodiment of the presenter configuration, the presenter view may be configured with a private preview area. The private preview area may be visible in the presenter view to the presenter but not in the slideshow view to the audience. As previously described, when a current slide is shown in the slideshow view to the audience, a reduced-size rendering of the current slide may be shown in the presenter view to the presenter. The presenter view may also include the private preview area, which shows a reduced-size rendering of a next transition of the slideshow set following a current transition of the current slide shown in the slideshow view. The next transition of the slideshow set may be either the next slide following the current slide or the next animation of the current slide. A sequence of transitions associated with the slideshow set may determine the next transition of the slideshow set.

In a fourth embodiment of the presenter configuration, the presenter view may be configured with a private black screen control. The private black screen control may be visible in the presenter view to the presenter but not in the slideshow view to the audience. The presenter may select the private black screen control in order to black out the slideshow view. When the slideshow view is blacked out, the presenter view may still be visible to the presenter.

In a fifth embodiment of the presenter configuration, the presenter view may be configured with a private show taskbar control. The private show taskbar control may be visible in the presenter view to the presenter but not in the slideshow view to the audience. The presenter may select the private show taskbar control in order to access the operating system taskbar. Through the operating system taskbar, the presenter may open another application during a presentation.

In a sixth embodiment of the presenter configuration, the presentation application may include private display settings control. The private display settings control may be visible in the presenter view to the presenter but not in the slideshow view to the audience. The private display settings control may include access to a swap function and a duplicate function. The presenter may perform the swap function in order to swap the presenter view and the slideshow view between the primary display device and the secondary display device. The presenter may perform the duplicate function in order to duplicate the slideshow view in both the primary display device and the secondary display device.

In a seventh embodiment of the presenter configuration, the presentation application may be configured with a private timer interface. The private timer interface may be visible in the presenter view to the presenter but not in the audience view to the audience. For example, when the presenter is ready to begin the presentation, the presenter may cause the presentation application to display the first slide in a slideshow set. When the presentation application displays the first slide, the presentation application may automatically start a timer that is utilized to keep track of the length of the presentation. However, although the presenter may be ready to give the presentation, the audience may not be ready. When the presenter determines that the audience is ready, the presenter may access a reset function in the private timer interface in order to reset the timer. In addition to the reset function, the private timer interface may also include a pause function for pausing the timer.

In an eighth embodiment of the presenter configuration, the presentation application may be configured with a private laser pointer control. The private laser pointer control may be visible in the presenter view to the presenter but not in the slideshow view to the audience. The presenter may select the private laser pointer control in order to show a laser pointer in the slideshow view. The laser pointer may be controlled, by way of example, by an input device coupled to the computer. The laser pointer may also be controlled using other technologies or methods, the present disclosure of which is not limited to any particular type.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

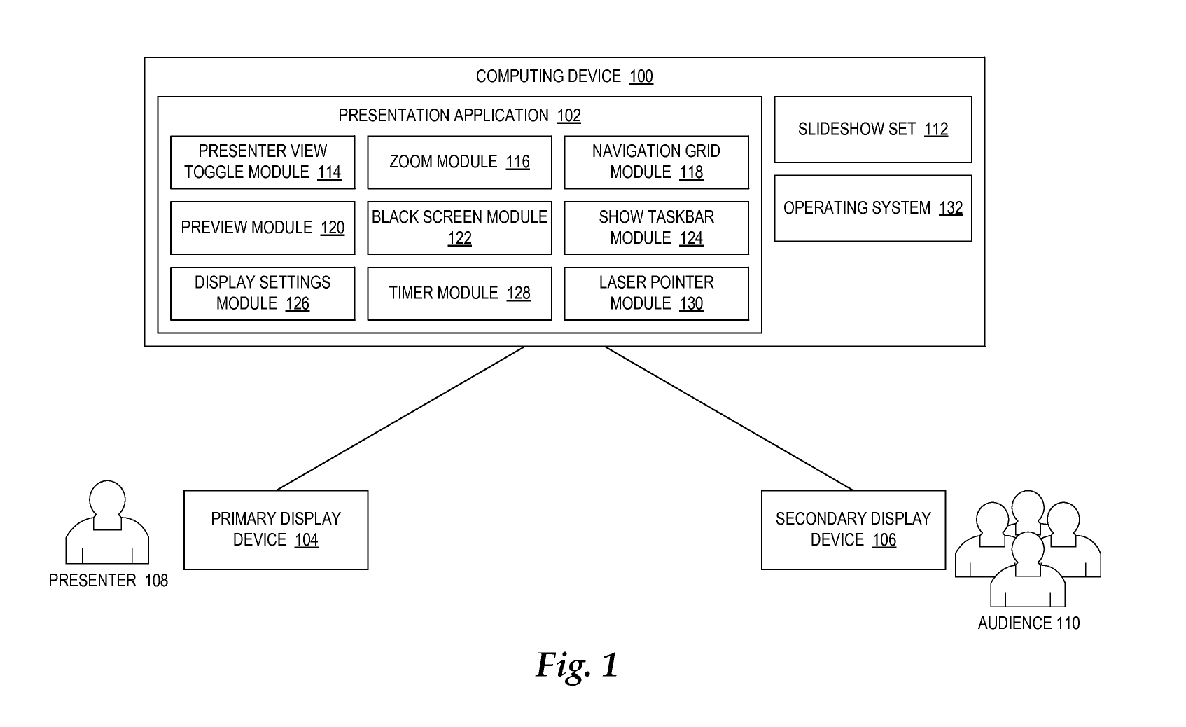

In the following detailed description, references are made to the accompanying drawings that form a part hereof, and which are shown by way of illustration, specific embodiments, or examples. Referring now to the drawings, in which like numerals represent like elements through the several figures, a computer system and methodology for providing a presenter view in a presentation application will be described. In particular, FIG. 1 is a block diagram illustrating a computing device 100 configured to provide a presenter view in a presentation application 102, in accordance with some embodiments presented herein. The computing device 100 may be coupled to a primary display device 104. The computing device 100 may also optionally be coupled to a secondary display device 106. In the example illustrated in FIG. 1, the primary display device 104 is visible to a presenter 108 and not to an audience 110, and the secondary display device 106 is visible to both the presenter 108 and the audience 110.

The computing device 100 may be configured to execute the presentation application 102. The presentation application 102 may provide functions enabling the presenter 108 to create a slideshow set 112. The presentation application 102 may also provide functions enabling the presenter 108 to present the slideshow set 112 to the audience 110. The slideshow set 112 may include multiple slides configured according to a defined sequence of transitions from the first slide to a last slide in the slideshow set 112. Each slide may be a static slide or an animated slide. A static slide may have a single view with no animations. Thus, a static slide may necessarily transition to the next slide. An animated slide may have multiple animations. Thus, an animated slide may transition through each of its animations before transitioning to the next slide.

For example, an illustrative slideshow set may include a first slide, a second slide, and a third slide. The first slide and the third slide may be static slides, and the second slide may be an animated slide. More specifically, the second slide may include a first animation in which one bullet is shown and a second animation in which two bullets are shown. In this example, the sequence of the slideshow set may be as follows: (1) the first slide followed by, (2) the first animation of the second slide followed by, (3) the second animation of the second slide followed by, (4) the third slide.

The presentation application 102 may include multiple program modules configured to provide various functions enabling the presenter 108 to present the slideshow set 112 to an audience. At least some of these program modules may provide functions related to providing a presenter view. Some example program modules may include a presenter view toggle module 114, a zoom module 116, a navigation grid module 118, a preview module 120, a black screen module 122, a show taskbar module 124, a display settings module 126, a timer module 128, and a laser pointer module 130.

When the presenter 108 is ready to start a presentation of the slideshow set 112, the presenter 108 may initiate execution of the presentation application 102 on the computing device 100. When the presenter 108 initiates execution of the presentation application 102, the presenter view toggle module 114 may determine whether the secondary display device 106 is coupled to the computing device 100. If the presenter view toggle module 114 determines that the secondary display device 106 is coupled to the computing device 100, then the presenter view toggle module 114 may configure the presentation application 102 in a presenter configuration.

In the presenter configuration, a presenter view may be shown on the primary display device 104, and a slideshow view may be shown on the secondary display device 106. The slideshow view may show a current slide from the slideshow set 112. The presenter view may include a current slide area, a private preview area, a notes area, and a control interface, in accordance with various embodiments. The current slide area may show a reduced-size rendering of the current slide that is concurrently shown in the slideshow view. The private preview area, which is described in greater detail below, may show a reduced-size rendering of a next slide following the current slide or a next animation of the current slide. The notes area may show presentation notes for the presenter 108.

The control interface may surface various controls for easily accessibility by the presenter 108. Conventionally, some of these controls may be accessible only by navigating through multiple layers of context menus. As described in greater detail below, some example controls may include a private zoom control provided by the zoom module 116, a private navigation grid control provided by the navigation grid module 118, a private black screen control provided by the black screen module 122, a private show taskbar control provided by the show taskbar module 124, a private display settings control provided by the display settings module 126, and a private laser pointer control provided by the laser pointer module 130.

If the presenter view toggle module 114 determines that the secondary display device 106 is not coupled to the computing device 100, then the presenter view toggle module 114 may configure the presentation application 102 in a default configuration. For example, in the default configuration, a standard interface may be shown on the primary display device 104. The standard interface may include functions enabling the presenter 108 to create and edit the slideshow set 112. Other implementations of the default configuration may be contemplated by one skilled in the art.

In some embodiments, the presentation application 102 may include a view selection function enabling the presenter 108 to manually select between the presenter view, the slideshow view, and any other views available. These views may be available even when the secondary display device 106 is not coupled to the computing device 100. For example, the presenter 108 may be rehearsing a presentation using a single display device. In this example, the presenter 108 may utilize the view selection function in order to toggle between the presenter view and the slideshow view on the single display device.

In some embodiments, the presenter view toggle module 114 may continuously monitor for the coupling of the secondary display device 106 to the computing device 100. For example, the secondary display device 106 may not be coupled to the computer 100 when the presentation application 102 is initially executed, thereby causing the presentation application 102 to be configured in the default configuration. At a later time while the presentation application 102 remains executing, the presenter 108 may couple the secondary display device 106 to the computing device 100. The presenter view toggle module 114 may detect this subsequent coupling of the secondary display device 106. In response to detecting the coupling of the secondary display device 106 to the computing device 100, in some examples, the presentation application 102 may transform from the default configuration to the presentation configuration. It should be appreciated that the default configuration may be transformed to the presentation configuration through other means or devices, the present disclosure of which is not intended to be limited to any specific technology or method. For example, a user may manually transform presentation application 102 from the default configuration to the presentation configuration using various hotkeys or commands.

In some embodiments, the presenter view toggle module 114 may communicate with an operating system 132 of the computing device 100 when configuring the presentation application 102 in the presenter configuration. For example, the operating system 132 may be configured to operate in a duplicate mode when additional display devices, such as the secondary display device 106, are coupled to the computing device 100. In the duplicate mode, the secondary display device 106 duplicates the view shown on the primary display device 104. Thus, the duplicate mode may not support the presenter configuration in which the presenter view shown on the primary display device 104 and the slideshow view shown on the secondary display device 106 are different.

In this regard, the presenter view toggle module 114 may instruct the operating system 132 to transform from the duplicate mode to an extended mode prior to configuring the presentation application 102 in the presenter configuration. In the extended mode, the secondary display device 106 may extend the screen area shown on the primary display device 104. That is, the extended mode may effectively combine the screen area of the primary display device 104 and screen area of the secondary display device 106 to form a single large screen area. By utilizing the secondary display device 106 to extend the screen area on the primary display device 104, the secondary display device 106 may show a different view from the primary display device 104, thereby supporting the presenter configuration.

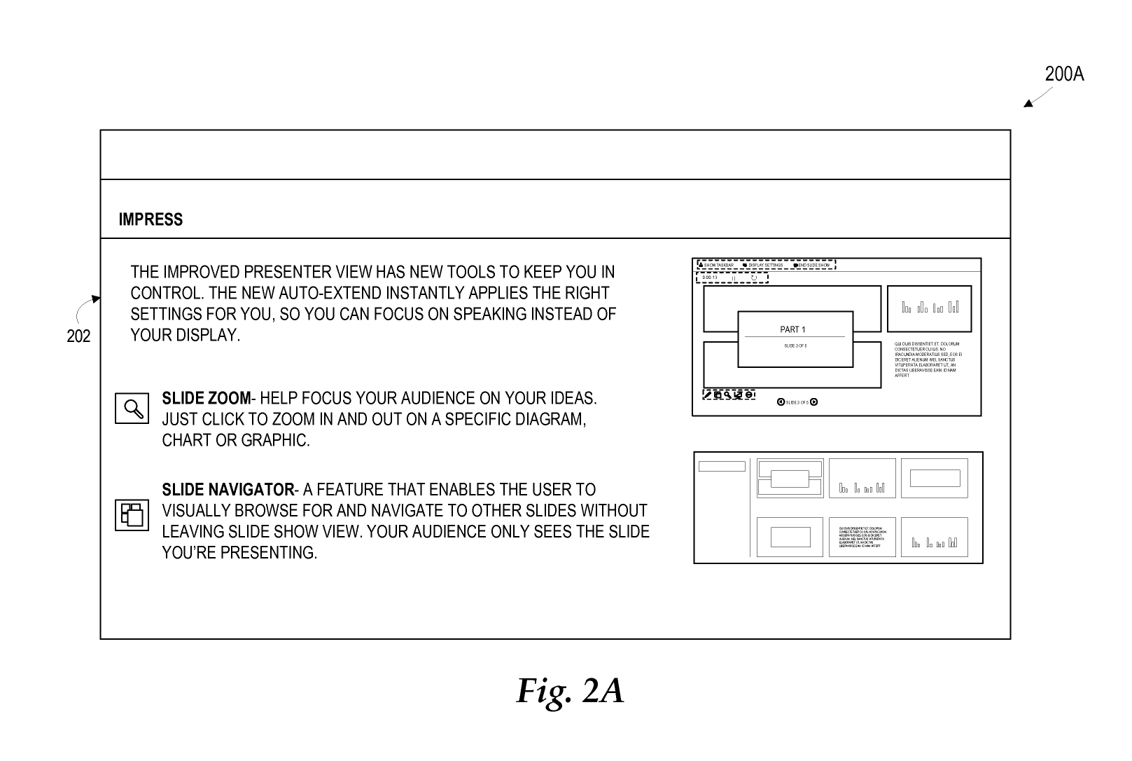

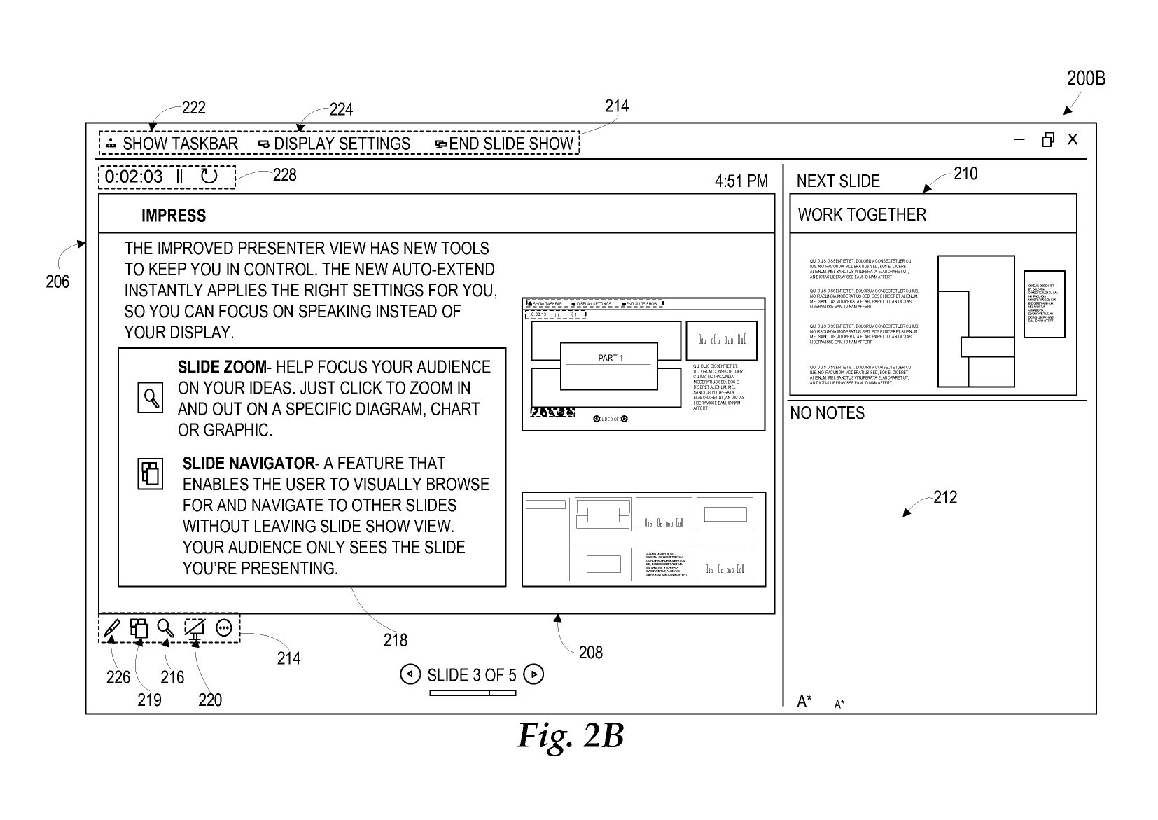

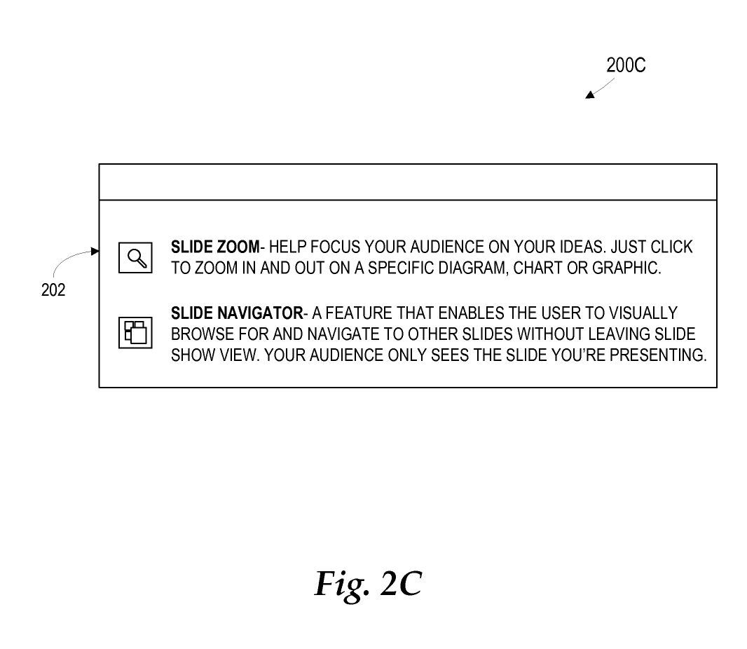

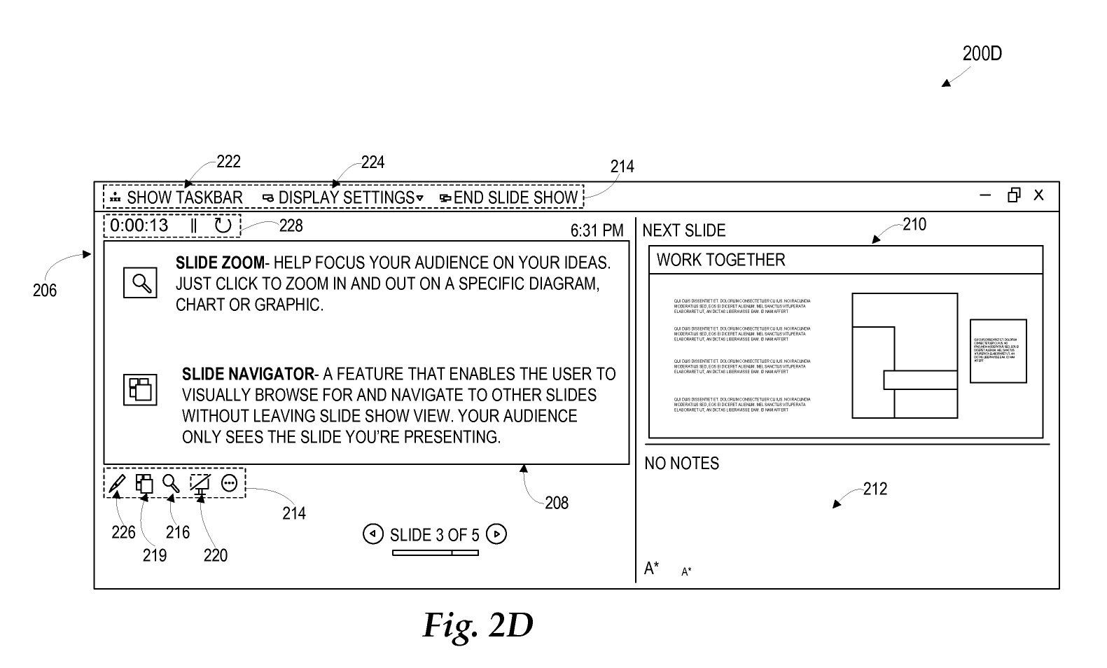

The zoom module 116 may provide a private zoom control, which is accessible by the presenter 108 through the control interface in the presenter view. As previously described, the current slide shown in the slideshow view may also be concurrently shown in the current slide area of the presenter view. The presenter 108 may select the private zoom control in the control interface in order to access a zoom interface in the current slide area. Through the zoom interface, the presenter 108 may identify a portion of the current slide that the presenter 108 desires to zoom in. When the presenter 108 is satisfied with the identified portion of the current slide, the presenter 108 may commit to the zoom interface. When the presenter 108 commits to the zoom interface, the zoom module 116 may cause the slideshow view (as well as the current slide area of the presenter view) to zoom in from the current slide to the identified portion of the current slide. The private zoom interface may also be configured to receive a user instruction to zoom out back to the current slide. In this case, the zoom module 116 may cause the slideshow view (as well as the current slide area of the presenter view) to zoom out from the identified portion of the current slide back to the current slide, in response to the user instruction to zoom out. An example of the zoom interface is illustrated in FIGS. 2A-2D, which are described below.

The navigation grid module 118 may provide the private navigation grid control, which is accessible by the presenter 108 through the control interface in the presenter view. The presenter 108 may select the private navigation grid control in order to access a navigation grid in the presenter view. The presentation application 102 may include functions enabling the presenter 108 to transition from the current slide displayed in the slideshow view to the next slide in the sequence of the slideshow set 112. In some instances, however, the presenter 108 may desire to transition to a slide outside of the sequence. In such instances, the presenter 108 may access the navigation grid via the private navigation grid control.

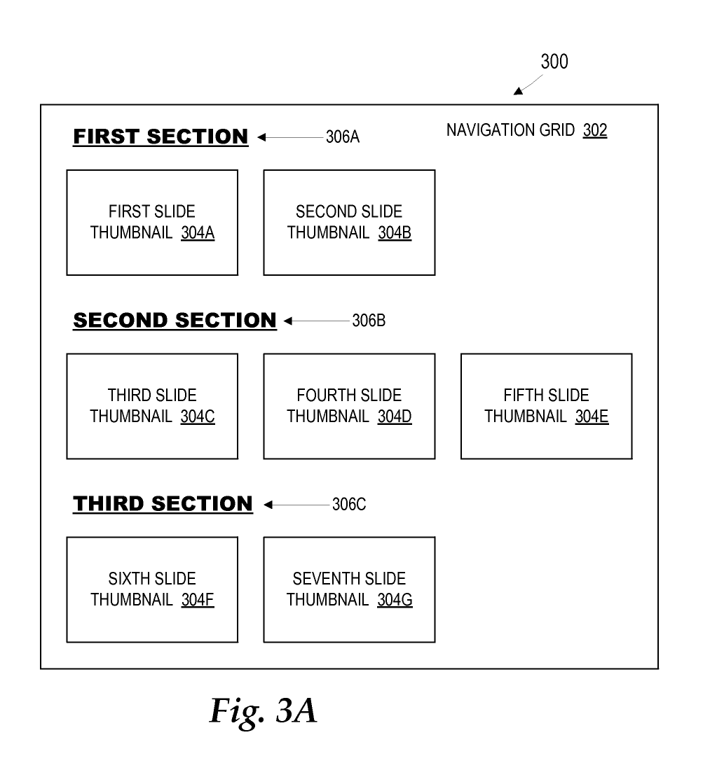

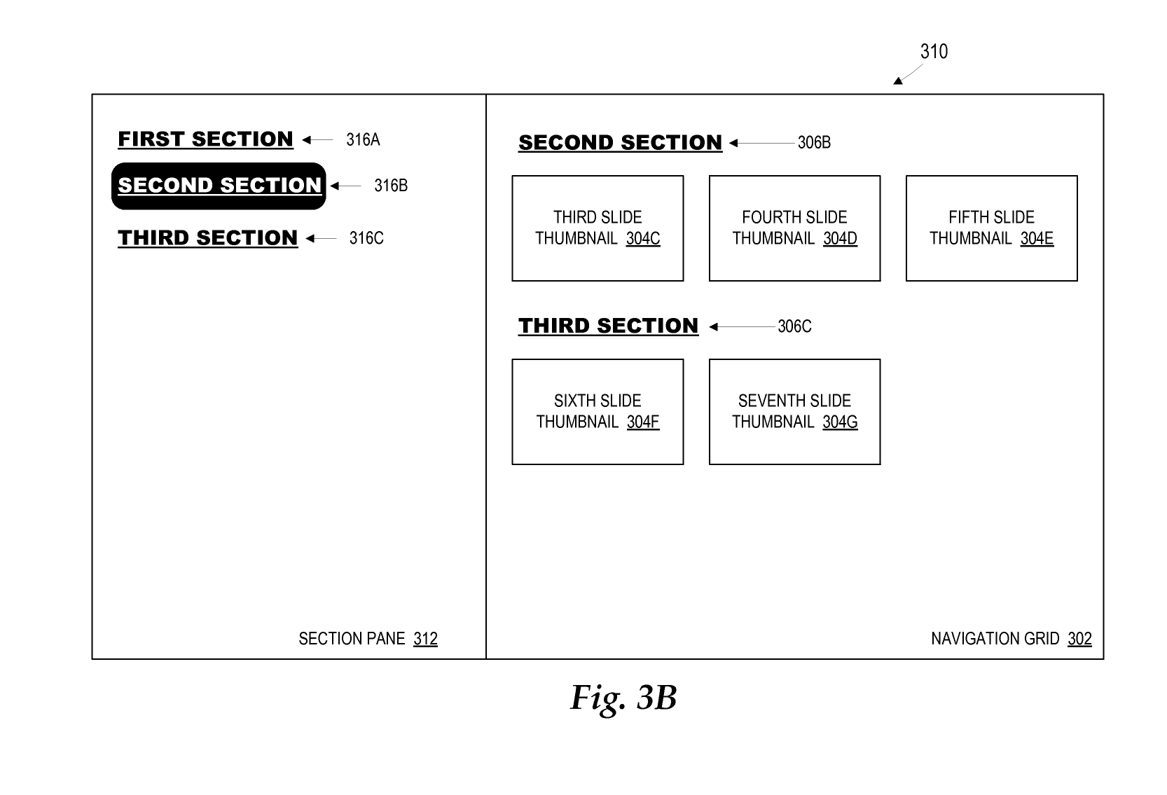

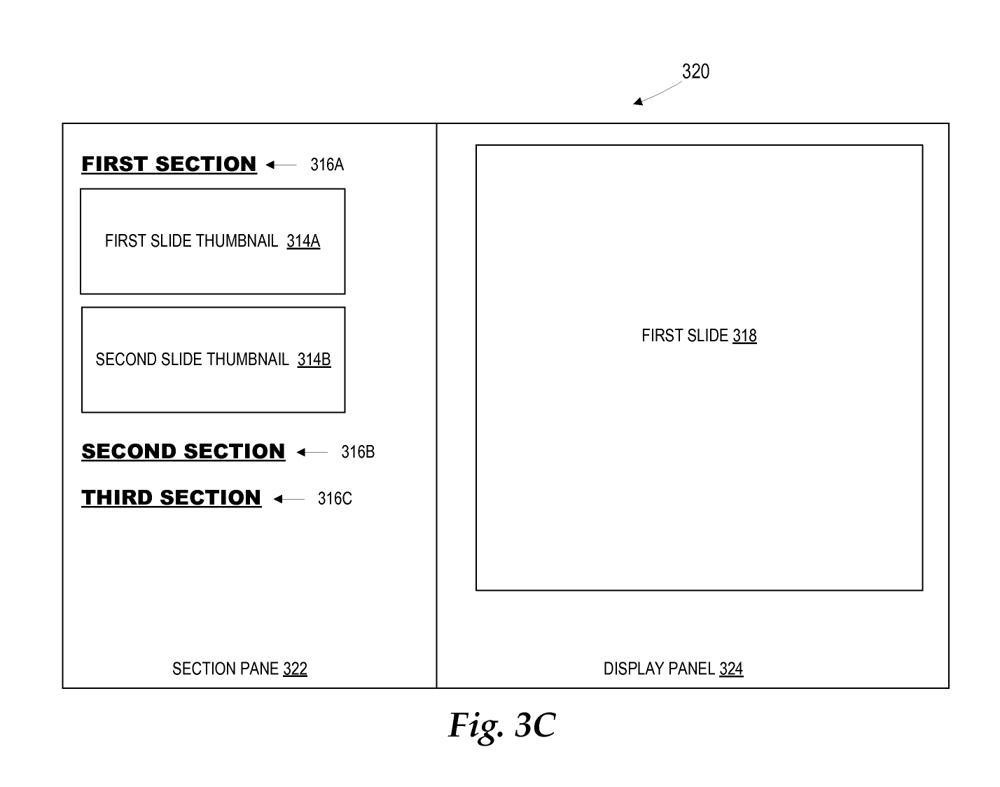

In particular, the navigation grid may contain thumbnail images of each slide in the slideshow set 112. If the slides in the slideshow set 112 are organized by section, then the navigation grid will show the thumbnail images of the slides as organized by section. Each thumbnail image may be selectable by the presenter 108. The presenter 108 may select a particular thumbnail image in order to transition from the current slide to the slide corresponding to the selected thumbnail image. Examples of the private navigation grid are illustrated in FIG. 3A-3C, which are described below.

The preview module 120 may provide the private preview area in the presenter view. The private preview area may show a reduced-size rendering of a next transition of the slideshow set 112 following a current transition of the current slide shown in the slideshow view. The next transition of the slideshow set 112 may be either the next slide following the current slide or the next animation of the current slide. In particular, if the current slide shown in the slideshow view is a static slide, then the private preview area will show the next slide. If the current slide shown in the slideshow view is an animation of an animated slide and the next transition in the sequence is another animation of the animated slide (i.e., all of the animations in the current slide have yet to be shown), then the private preview area will show the next animation of the current slide. If the current slide shown in the slideshow view is an animation of an animated slide and the next transition in the sequence is the next slide (i.e., all of the animations in the current slide have been shown), then the private preview area will show the next slide. An example of the private preview area is illustrated in FIGS. 2B and 2D, which are described below.

The black screen module 122 may provide the private screen control, which is accessible by the presenter 108 through the control interface in the presenter view. The presenter 108 may access the private screen control in order to black out the slideshow view. As used herein, the term “black out” may refer generally to any action that effectively covers the current slide shown in the slideshow view. The presenter view may still be visible to the presenter 108 when the slideshow view is blacked out. For example, the presenter view may show in a current slide area that the current slide is blacked out. In one example, the presenter 108 may black out the slideshow view when the presenter 108 begins discussing subject matter unrelated to the current slide shown in the slideshow view. In another example, the presenter 108 may black out the slideshow view when, during a presentation of confidential information to a select group, another person outside of the group walks in on the presentation. An example of the private screen control is illustrated in FIGS. 2B and 2D, which are described below.

The show taskbar module 124 may provide the private show taskbar control, which is accessible by the presenter 108 through the control interface in the presenter view. The presenter 108 may select the private show taskbar control in order to access a taskbar as provided by the operating system 132. Through the taskbar, the presenter 108 may open another application during a presentation. An example of the private show taskbar control is illustrated in FIGS. 2B and 2D, which are described below.

The display settings module 126 may provide the private display settings control, which is accessible by the presenter 108 through the control interface in the presenter view. The private display settings control may include access to a swap function and a duplicate function. The presenter 108 may perform the swap function in order to swap the presenter view and the slideshow view between the primary display device 104 and the secondary display device 106. For example, the primary display device 104 may show presenter view, and the secondary display device 106 may show the slideshow view. After the presenter 108 performs the swap function, the primary display device 104 may show the slideshow view, and the secondary display device 106 may show the presenter view. The presenter 108 may perform the duplicate function in order to duplicate the slideshow view in both the primary display device 104 and the secondary display device 106. An example of the private display settings control is illustrated in FIGS. 2B and 2D, which are described below.

The timer module 128 may provide the private timer interface, which is accessible by the presenter 108 through the presenter view. The private timer interface may be visible in the presenter view to the presenter 108 but not in the slideshow view to the audience 110. When the presenter 108 is ready to begin the presentation, the presenter 108 may cause the presentation application 102 to display the first slide in a slideshow set 112. When the presentation application 102 displays the first slide, the presentation application 102 may automatically start a timer that is utilized to keep track of the length of the presentation. However, although the presenter 108 may be ready to give the presentation, the audience 110 may not be ready. When the presenter 108 determines that the audience 110 is ready, the presenter 108 may access a reset function in the private timer interface in order to reset the timer. In addition to the reset function, the private timer interface may also include a pause function for pausing the timer. An example of the private timer interface is illustrated in FIGS. 2B and 2D, which are described below.

The laser pointer module 130 may provide the private laser pointer control, which is accessible by the presenter 108 through the control interface in the presenter view. The presenter 108 may select the private laser pointer control in order to show a laser pointer in the slideshow view. The presenter 108 may control the laser pointer, for example, but not limited to, by using an input device coupled to the computing device 100. It should be appreciated that the presenter 108 may control the laser pointer using other systems or methods, such as the presenter's finger on a device capable of receiving “touch” input, the present disclosure of which is not limited to any particular way of controlling the laser pointer. An example of the private laser pointer control is illustrated in FIGS. 2B and 2D, which are described below.

Referring now to FIGS. 2A-2D and 3, additional details regarding the operation of the presentation application 102. In particular, FIGS. 2A-2D are screen display diagrams illustrating an example process for zooming in on a slide, in accordance with some embodiments presented herein. FIG. 2A is a screen display diagram 200A showing an example implementation of a slideshow view 202 shown on the secondary display device 106 to the audience 110. As illustrated in FIG. 2A, the slideshow view 202 shows a current slide from the slideshow set 112.

FIG. 2B is a screen display diagram 200B showing an example implementation of the presenter view 206 shown on the primary display device 104 to the presenter 108. As illustrated in FIG. 2B, the presenter view 206 includes a current slide area 208, a private preview area 210, a notes area 212, and a control interface 214. The current slide area 208 may show a reduced-size rendering of the current slide shown in the slideshow view 202. The private preview area 210 may show a reduced-size rendering of the next transition following the current transition of the current slide shown in the slideshow view. The next transition may be the next slide following the current slide or the next animation of the current slide. The control interface 214 may refer generally to various interface elements arranged on the presenter view 206. These interface elements may provide quick access to certain commonly-used controls without the need to navigate multiple layers of context menus.

In some embodiments, the control interface 214 may include a private zoom control 216. The presenter 108 may select the private zoom control 216 in order to access a zoom interface 218 in the private preview area 210. For example, the presenter 108 may select the private zoom control 216 via a sequence of one or more mouse clicks or one or more taps/gestures via a touchscreen interface. In some embodiments, the presenter 108 may select the private zoom control 216 via a toggle button, whereby a first click or tap of the toggle button enters the private zoom control 216 and the second click or tap of the toggle button exits the private zoom control 216. Once in private zoom control 216, various means may be used by the presenter 108 to control the zoom, including, but not limited to, a “stretch” gesture using a multi-touch capability or various keyboard shortcuts. It should be appreciated that the concepts and technologies disclosed herein are not limited to requiring the private zoom control 216, as other zoom control techniques may be implemented, all considered to be within the scope of the present disclosure. For example, and not by way of limitation, when using an input device such as a keyboard and/or touchscreen interface, the presenter 108 may use other zoom gestures or shortcuts in the control interface 214 or at various interfaces used by the presenter 108. In some configurations, the use of shortcuts or other zoom inputs can cause the private zoom control 216 to be implemented.

As illustrated in FIG. 2B, the zoom interface 218 may be implemented as a rectangular frame. It should be appreciated that the zoom interface 218 may be implemented as other geometric or freeform shapes as contemplated by one skilled in the art. The zoom interface 218 may be moved to encompass any portion of the current slide. The zoom interface 218 may be made larger or smaller to encompass a larger or smaller portion of the current slide. In some embodiments, the zoom interface 218 may be fixed. If the zoom interface 218 is not fixed, when the presenter 108 is satisfied with the location and size of the zoom interface 218, the presenter 108 may commit to the zoom interface 218. For example, the presenter 108 may commit to the zoom interface 218 via a sequence of one or more mouse clicks or one or more taps/gestures via a touchscreen interface. In one example, and not by way of limitation, if using touch, presenter 108 may use one or more stretch gestures on the slide area 216, and then one or more pan gestures on the slide area 208.

FIG. 2C is a screen display diagram 200C showing an example implementation of the slideshow view 202 after the presenter 108 has committed to the zoom interface 218. In particular, the slideshow view 202 has transformed from showing the current slide, as illustrated in FIG. 2A, to showing a portion of the current slide encompassed by the zoom interface 218, as illustrated in FIG. 2B.

FIG. 2D is a screen display diagram 200D showing an example implementation of the presenter view 206 after the presenter 108 has committed to the zoom interface 218. In particular, the current slide area 208 has transformed from showing a reduced-size rendering of the current slide to showing a reduced-size rendering of the portion of the current slide encompassed by the zoom interface 218.

As illustrated in FIGS. 2B and 2D, the control interface 214 may include, in addition to the private zoom control 216, a private navigation grid control 219, a private black screen control 220, a private show taskbar control 222, a private display settings control 224, and a private laser pointer control 226. In some embodiments, laser pointer control 226 is a button that may also provide for other services such as inking tools, including a pen, a highlighter, and an eraser. Also as illustrated in FIGS. 2B and 2D, the presenter view 206 may include a private timer interface 228.

FIG. 3A is a screen display diagram 300 showing an example implementation of a navigation grid 302, in accordance with some embodiments presented herein. The presenter 108 may access the navigation grid 302 by selecting the private navigation grid control 219. As illustrated in FIG. 3A, the navigation grid 302 shows a first slide thumbnail image 304A, a second slide thumbnail image 304B, a third slide thumbnail image 304C, a fourth slide thumbnail image 304D, a fifth slide thumbnail image 304E, a sixth slide thumbnail image 304F, and a seventh slide thumbnail image 304G. Each of the thumbnail images 304A-304G may correspond to a slide in the slideshow set 112.

The first slide thumbnail image 304A and the second slide thumbnail image 304B may be organized by a first section 306A. This indicates that the first slide corresponding to the first slide thumbnail image 304A and the second slide corresponding to the second slide thumbnail image 304B are organized by the first section 306A, as defined by the slideshow set 112. The third slide thumbnail image 304C thumbnail image, the fourth slide thumbnail image 304D, and the fifth slide thumbnail image 304E may be organized by a second section 306B. This indicates that the third slide corresponding to the third slide thumbnail image 304C, the fourth slide corresponding to the fourth slide thumbnail image 304D, and the fifth slide corresponding to the fifth slide thumbnail image 304E are organized by the second section 306B, as defined by the slideshow set 112. The sixth slide thumbnail image 304F and the seventh slide thumbnail image 304G may be organized by a third section 306C. This indicates that the sixth slide corresponding to the sixth slide thumbnail image 304F and the seventh slide corresponding to the seventh slide thumbnail image 304G are organized by the third section 306C, as defined by the slideshow set 112.

The presenter 108 may utilize the navigation grid 302 in order to transition to any slide in the slideshow set 112. In an illustrative example, the current slide shown in the slideshow view is the first slide. The sequence of transitions associated with the slideshow set 112 may define the next transition as the second slide. However, due to an impromptu change in the presentation, the presenter 108 may desire to transition to the sixth slide. In this case, the presenter 108 may access the navigation grid 302 and select the sixth slide thumbnail image 304F. When the presenter 108 selects the sixth slide thumbnail image 304F, the slideshow view may display the corresponding sixth slide.

FIG. 3B is a screen display diagram 310 showing an example implementation of the navigation grid 302 in combination with a section pane 312, in accordance with some embodiments presented herein. The presenter 108 may access the combination of the navigation grid 302 and the section pane 312 by selecting the private navigation grid control 219. As illustrated in FIG. 3B, the section pane 312 shows a first section title 316A, a second section title 316B, and a third section title 316C (collectively “section titles 316A-316C) displayed in the section pane 312. Each of the section titles 316A-316C may correspond to sections of the slideshow set 112. The presenter 108 can jump to a section by selecting one of the section titles 316A-316C.

When one of the section titles 316A-316C is selected, the section title that was selected can be highlighted. Additionally, the corresponding section can be displayed at the top of the navigation grid 302. FIG. 3B illustrates an example, wherein the second section title 316B is selected. The selection of the second section title 316B causes the second section 306B to be displayed at the top of the navigation grid 302. In some configurations, moving the second section 306B to the top of the navigation grid 302 may cause sections following the second section 306B to move up as well, illustrated as the third section 306C being shown as moving towards the middle of the navigation grid 302, with the first section 306A removed from view due to the position of the second section 306B at the top of the navigation grid 302.

FIG. 3C is a screen display diagram showing an alternative example implementation of a section pane 322, in accordance with some embodiments presented herein. The section pane 322 and a display panel 324 are configured to display one or more thumbnail images and at least one slide of a particular section selected by the presenter 108. The presenter 108 may use the section pane 322 to select and expand one or more sections corresponding to the section titles 316A-316C. In FIG. 3C, the first section title 316A has been selected, causing an expansion to show the first slide thumbnail image 314A and the second slide thumbnail image 314B. Also displayed in the display panel 324 is a first slide 318 corresponding to the first slide thumbnail image 314A. The presenter 108 may select and deselect the section titles 316A-316C to expand and compress the particular sections in the section pane 322.

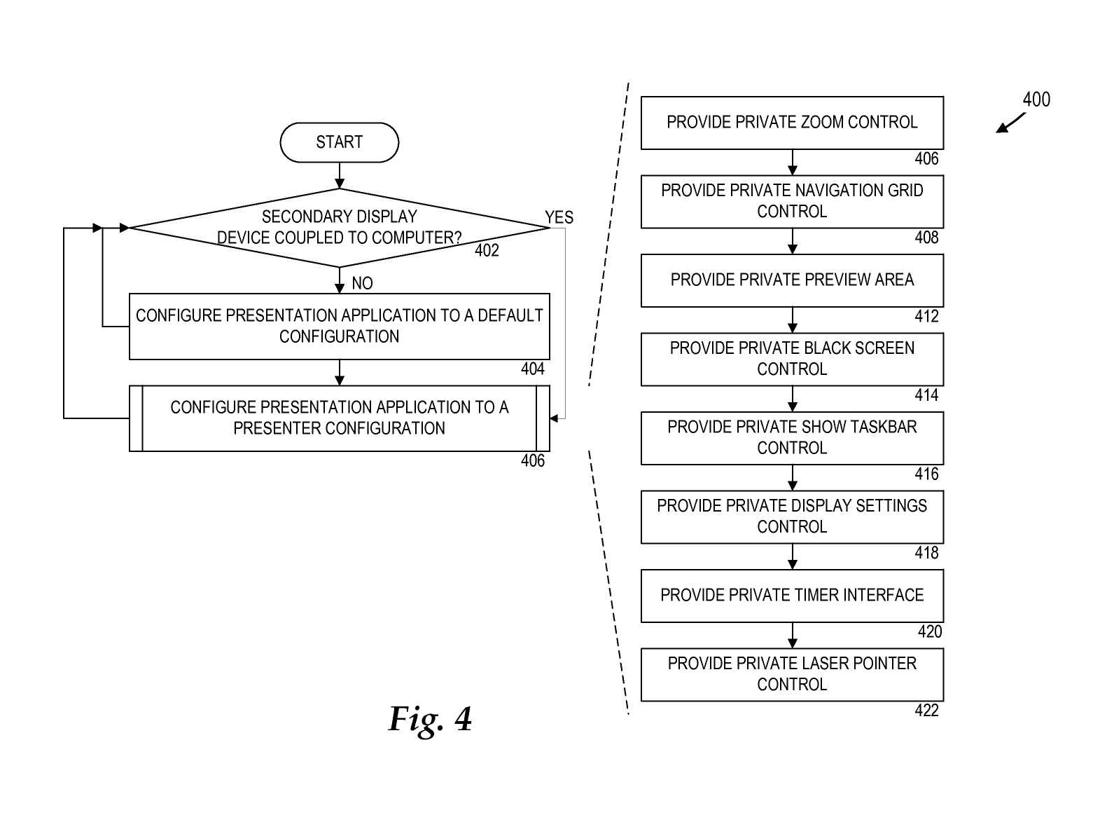

Referring now to FIG. 4, additional details regarding the operation of the presentation application 102 will be described. In a particular, FIG. 4 is a flow diagram illustrating an example method for providing a presenter view in a presentation application, such as the presentation application 102, in accordance with some embodiments presented herein.

It should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states operations, structural devices, acts, or modules. These operations, structural devices, acts, and modules may be implemented in software, in firmware, in special purpose digital logic, and any combination thereof. It should be appreciated that more or fewer operations may be performed than shown in the figures and described herein. These operations may also be performed in a different order than those described herein.

In FIG. 4, the routine 400 begins at operation 402, where the presentation application 102 determines whether the secondary display device 106 is coupled to the computing device 100. If the presentation application 102 determines that the secondary display device 106 is not coupled to the computing device 100, then the routine 400 proceeds to operation 404. At operation 404, the presentation application 102 configures to the default configuration. After operation 404, the routine 400 may return to operation 402, where the presentation application 102 continues to monitor for the coupling/decoupling of the secondary display device 106. In some embodiments, user action may be required to determine that operation 402 has occurred.

If the presentation application 102 determines that the secondary display device 106 is coupled to the computing device 100, then the routine 400 proceeds to operation 406. At operation 406, the presentation application 102 configures to the presenter configuration. In the presenter configuration, the presenter view 206 may be displayed on the primary display device 104, and the slideshow view 202 may be displayed on the secondary display device 106.

According to various embodiments, configuring the presentation application 102 to the presenter configuration includes one or more operations 408-422. At operation 408, the presentation application 102 provides the private zoom control 216 configured to access the zoom interface 218 in the presenter view 206. At operation 410, the presentation application 102 provides the private navigation grid control 219 configured to access the navigation grid 302 in the presenter view 206. At operation 412, the presentation application 102 provides the private preview area 210 in the presenter view 206. At operation 414, the presentation application 102 provides the private black screen control 220 configured to black out the slideshow view 202.

At operation 416, the presentation application 102 provides the private show taskbar control 222 configured to access a taskbar of the operating system 132. At operation 418, the presentation application 102 provides the private display settings control 224 configured to provide access to the swap function and the duplicate function. At operation 420, the presentation application 102 provides the private timer interface 228 configured to pause and reset a timer that begins when a first slide of a slideshow set 112 is presented. At operation 422, the presentation application 102 provides the private laser pointer control 226 configured to provide a laser pointer in the slideshow view 202. After operation 406, the routine 400 may return to operation 402, where the presentation application 102 continues to monitor for the coupling/decoupling of the secondary display device 106. In some embodiments, it may be necessary for a user to provide some input that the coupling/decoupling of the secondary display device has occurred. For example, and not by way of limitation, presentation application 102 may not be configured to automatically detect the coupling and/or decoupling of the secondary display device 106.

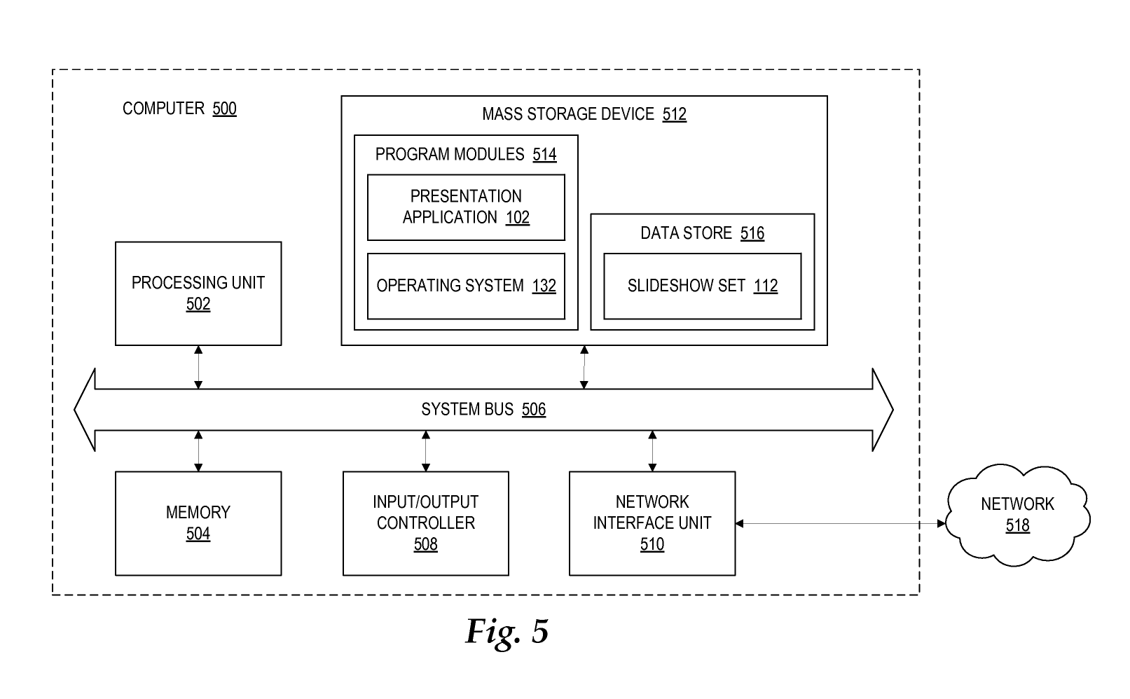

FIG. 5 is an example computer architecture diagram illustrating a computer 500. Examples of the computer 500 may include computing device 100. The computer 500 may include a central processing unit 502, a system memory 504, and a system bus 506 that couples the memory 504 to the central processing unit 502. The computer 500 may further include a mass storage device 512 for storing one or more program modules 514 and a data store 516. Examples of the program modules 514 may include the presentation application 102 and the operating system 132. The data store 516 may store the slideshow set 112. In some embodiments, the presentation application 102 may be configured to perform the method described with respect to FIG. 4. The mass storage device 512 may be connected to the processing unit 502 through a mass storage controller (not shown) connected to the bus 506. The mass storage device 512 and its associated computer-storage media may provide non-volatile storage for the computer 500. Although the description of computer-storage media contained herein refers to a mass storage device, such as a hard disk or CD-ROM drive, it should be appreciated by those skilled in the art that computer-storage media can be any available computer storage media that can be accessed by the computer 500.

By way of example, and not limitation, computer-storage media may include volatile and non-volatile, removable and non-removable media implemented in any method or technology for the non-transitory storage of information such as computer-storage instructions, data structures, program modules, or other data. For example, computer-storage media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer 500.

According to various embodiments, the computer 500 may operate in a networked environment using logical connections to remote computers through a network 518. The computer 500 may connect to the network 518 through a network interface unit 510 connected to the bus 506. It should be appreciated that the network interface unit 510 may also be utilized to connect to other types of networks and remote computer systems. The computer 500 may also include an input/output controller 508 for receiving and processing input from a number of input devices (not shown), including a keyboard, a mouse, a microphone, and a game controller. The input/output controller 508 may also be configured to receive user input via gestures, tap/touch (e.g., via a touchscreen), and/or voice. Similarly, the input/output controller 508 may provide output to a display, such as the primary display device 104 and the secondary display device 106, or other type of output device (not shown).

The bus 506 may enable the processing unit 502 to read code and/or data to/from the mass storage device 512 or other computer-storage media. The computer-storage media may represent apparatus in the form of storage elements that are implemented using any suitable technology, including but not limited to semiconductors, magnetic materials, optics, or the like. The computer-storage media may represent memory components, whether characterized as RAM, ROM, flash, or other types of technology. The computer-storage media may also represent secondary storage, whether implemented as hard drives or otherwise. Hard drive implementations may be characterized as solid state, or may include rotating media storing magnetically-encoded information.

The program modules 514 may include software instructions that, when loaded into the processing unit 502 and executed, cause the computer 500 to generate field sets. The program modules 514 may also provide various tools or techniques by which the computer 500 may participate within the overall systems or operating environments using the components, flows, and data structures discussed throughout this description. For example, the program modules 514 may implement interfaces for generating field sets.

In general, the program modules 514 may, when loaded into the processing unit 502 and executed, transform the processing unit 502 and the overall computer 500 from a general-purpose computing system into a special-purpose computing system customized to generate field sets. The processing unit 502 may be constructed from any number of transistors or other discrete circuit elements, which may individually or collectively assume any number of states. More specifically, the processing unit 502 may operate as a finite-state machine, in response to executable instructions contained within the program modules 514. These computer-executable instructions may transform the processing unit 502 by specifying how the processing unit 502 transitions between states, thereby transforming the transistors or other discrete hardware elements constituting the processing unit 502.

Encoding the program modules 514 may also transform the physical structure of the computer-storage media. The specific transformation of physical structure may depend on various factors, in different implementations of this description. Examples of such factors may include, but are not limited to: the technology used to implement the computer-storage media, whether the computer-storage media are characterized as primary or secondary storage, and the like. For example, if the computer-storage media are implemented as semiconductor-based memory, the program modules 514 may transform the physical state of the semiconductor memory, when the software is encoded therein. For example, the program modules 514 may transform the state of transistors, capacitors, or other discrete circuit elements constituting the semiconductor memory.

As another example, the computer-storage media may be implemented using magnetic or optical technology. In such implementations, the program modules 514 may transform the physical state of magnetic or optical media, when the software is encoded therein. These transformations may include altering the magnetic characteristics of particular locations within given magnetic media. These transformations may also include altering the physical features or characteristics of particular locations within given optical media, to change the optical characteristics of those locations. Other transformations of physical media are possible without departing from the scope of the present description, with the foregoing examples provided only to facilitate this discussion.

Based on the foregoing, it should be appreciated that concepts and technologies for providing a presenter view in a presentation application are presented herein. Although the subject matter presented herein has been described in language specific to computer structural features, methodological acts, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

What is claimed is:

1. A computer-implemented method for providing a presenter view in a presentation application, the method comprising:
determining, by the presentation application executing on a computer, whether a secondary display device is coupled to the computer; and
responsive to determining that the secondary display device is coupled to the computer, transforming the presentation application from a default configuration to a presenter configuration.

2. The method of claim 1, wherein transforming the presentation application from the default configuration to the presenter configuration comprises:
providing a presenter view on a primary display device coupled to the computer; and
providing a slideshow view on the secondary display device.

3. The method of claim 2, wherein providing the presenter view on the primary display device comprises:
providing, in the presenter view, a private zoom control enabling a presenter to access a zoom interface in the presenter view, wherein the private zoom control and the zoom interface are not visible in the slideshow view;
receiving a commitment to the zoom interface of a portion of a current slide; and
responsive to receiving the commitment to the zoom interface, transforming the slideshow view from a first display of the current slide to a second display of the portion of the current slide.

4. The method of claim 2, wherein providing the presenter view on the primary display device comprises:
providing, in the presenter view, a private navigation grid control enabling a presenter to access a navigation grid, the navigation grid comprising a plurality of thumbnail images, each of the thumbnail images corresponding to a slide in a slideshow set, wherein the plurality of thumbnail images are organized by sections as defined by the slideshow set;
receiving a selection of a thumbnail image in the plurality of thumbnail images; and
responsive to receiving the selection of the thumbnail image, transforming the slideshow view from a first display of a current slide to a second display of a slide corresponding to the selected thumbnail image.

5. The method of claim 2, wherein providing the presenter view on the primary display device comprises:
providing, in the presenter view, a private preview area configured to display either a next slide following a current slide or a next animation of the current slide, wherein the next slide is displayed when a next transition of a slideshow set is the next slide, wherein the next animation is displayed when the next transition is the next animation of the current slide, and wherein the private preview area is not visible in the slideshow view.

6. The method of claim 2, wherein providing the presenter view on the primary display device comprises:
providing, in the presenter view, a private black screen control enabling a presenter to black out the slideshow view without blacking out the presenter view, wherein the private black screen control is not visible in the slideshow view.

7. The method of claim 2, wherein providing the presenter view on the primary display device comprises:
providing, in the presenter view, a private show taskbar control enabling a presenter to access an operating system taskbar, the operating system taskbar enabling the presenter to open application, wherein the private show taskbar control is not visible in the slideshow view.

8. The method of claim 2, wherein providing the presenter view on the primary display device comprises:
providing, in the presenter view, a private display settings control enabling a presenter to perform a swap function and a duplicate function, the swap function causing the primary display device to swap between showing the presenter view and showing the slideshow view, the duplicate function causing the computer to switch between an extended display mode and a duplicate display mode, wherein the private display settings control is not visible in the slideshow view.

9. The method of claim 2, wherein providing the presenter view on the primary display device comprises:
providing, in the presenter view, a private timer interface enabling a presenter to pause and reset a timer that begins when a first slide of a slideshow set is presented, wherein the private timer interface is not visible in the slideshow view.

10. The method of claim 1, further comprising:
responsive to determining that the secondary displace device is decoupled from the computer, transforming the presentation application from the presenter configuration to the default configuration.

11. A computer-readable storage medium having computer-executable instructions stored thereon which, when executed by a computer, cause the computer to:
determine, by a presenter application executing on the computer, whether a secondary display device is coupled to the computer; and
responsive to determining that the secondary display device is coupled to the computer, transform the presentation application from a default configuration to a presenter configuration, the presenter configuration providing a presenter view on a primary display device coupled to the computer and providing a slideshow view on the secondary display device.

12. The computer-readable storage medium of claim 11, wherein to provide the presenter view on the primary display device, the computer-executable instructions, when executed by the computer, cause the computer to:
provide, in the presenter view, a private zoom control enabling a presenter to access a zoom interface in the presenter view, wherein the private zoom control and the zoom interface are not visible in the slideshow view;
receive a commitment to the zoom interface of a portion of a current slide; and
responsive to receiving the commitment to the zoom interface, transform the slideshow view from a first display of the current slide to a second display of the portion of the current slide.

13. The computer-readable storage medium of claim 11, wherein to provide the presenter view on the primary display device, the computer-executable instructions, when executed by the computer, cause the computer to:
provide, in the presenter view, a private navigation grid control enabling a presenter to access a navigation grid, the navigation grid comprising a plurality of thumbnail images, each of the thumbnail images corresponding to a slide in a slideshow set, wherein the plurality of thumbnail images are organized by sections as defined by the slideshow set;
receive a selection of a thumbnail image in the plurality of thumbnail images; and
responsive to receiving the selection of the thumbnail image, transform the slideshow view from a first display of a current slide to a second display of a slide corresponding to the selected thumbnail image.

14. The computer-readable storage medium of claim 11, wherein to provide the presenter view on the primary display device, the computer-executable instructions, when executed by the computer, cause the computer to:
provide, in the presenter view, a private preview area configured to display either a next slide following a current slide or a next animation of the current slide, wherein the next slide is displayed when a next transition of a slideshow set is the next slide, wherein the next animation is displayed when the next transition is the next animation of the current slide, and wherein the private preview area is not visible in the slideshow view.

15. The computer-readable storage medium of claim 11, wherein to provide the presenter view on the primary display device, the computer-executable instructions, when executed by the computer, cause the computer to:
provide, in the presenter view, a private black screen control enabling a presenter to black out the slideshow view without blacking out the presenter view, wherein the private black screen control is not visible in the slideshow view.

16. The computer-readable storage medium of claim 11, wherein to provide the presenter view on the primary display device, the computer-executable instructions, when executed by the computer, cause the computer to:
provide, in the presenter view, a private show taskbar control enabling a presenter to access an operating system taskbar, the operating system taskbar enabling the presenter to open application, wherein the private show taskbar control is not visible in the slideshow view.

17. The computer-readable storage medium of claim 11, wherein to provide the presenter view on the primary display device, the computer-executable instructions, when executed by the computer, cause the computer to:
provide, in the presenter view, a private display settings control enabling a presenter to perform a swap function and a duplicate function, the swap function causing the primary display device to swap between showing the presenter view and showing the slideshow view, the duplicate function causing the computer to switch between an extended display mode and a duplicate display mode, wherein the private display settings control is not visible in the slideshow view.

18. The computer-readable storage medium of claim 11, wherein to provide the presenter view on the primary display device, the computer-executable instructions, when executed by the computer, cause the computer to:
provide, in the presenter view, a private timer interface enabling a presenter to pause and reset a timer that begins when a first slide of a slideshow set is presented, wherein the private timer interface is not visible in the slideshow view.

19. The computer-readable medium of claim 11, wherein to provide the presenter view on the primary display device, the computer-executable instructions, when executed by the computer, cause the computer to:
provide, in the presenter view, a private laser pointer control enabling the presenter to initiate a laser pointer shown in the slideshow view, wherein the private laser pointer control is not visible in the slideshow view.

20. A computer system, comprising:
a processor;
a memory communicatively coupled to the processor; and
a program module which executes in the processor from the memory and which, when executed by the processor, causes the processor to:
determine, by a presenter application executing on the computer system, whether a secondary display device is coupled to the computer system,
responsive to determining that the secondary display device is coupled to the computer system, transform the presentation application from a default configuration to a presenter configuration, the presenter configuration providing a presenter view on a primary display device coupled to the computer and providing a slideshow view on the secondary display device, the presenter view comprising a private zoom control configured to access a zoom interface in the presenter view, a private navigation grid control configured to access a navigation grid in the presenter view, and a private preview area, and
responsive to determining that the secondary device is decoupled from the computer system, transform the presentation application from the presenter configuration to the default configuration.
